(19) United States
(12) Patent Application Publication
(10) Pub. No.: US 2003/0009426 A1
(43) Pub. Date: Jan. 9, 2003

(54) Methods and apparatus for protecting against credit card fraud, check fraud, and identity theft

(76) Inventor: Marcelo Ruiz-Sanchez, Jacksonville, FL (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/125,645

(22) Filed: Apr. 19, 2002

Related U.S. Application Data
(60) Provisional application No. 60/284,506, filed on Apr. 19, 2001.

(51) Int. Cl. G06F 17/60

(52) U.S. Cl. 705/78

(57) ABSTRACT

A notification of an electronic transaction representing a debit or credit card, altered check amount or creation new credit/loan by other person using a stolen identity on a money transaction to be processed later, by the ATM machine, bank service, or credit/loan approval respectively for a fraudulent transaction is disclosed. A method detects a fraudulent transaction. It includes notifying customers of transactions being executed; examining a set of transaction classes (TC) which would fulfill the terms of a threshold transaction list (TTL) to determine if specified TC is a fraudulent transaction; and providing threshold transaction parameter(s) exceeded prior to realizing specified TC.

This application claims the benefit of the Apr. 19, 2001 filing date of U.S. Provisional Patent Application No. 60/284,506, which is hereby incorporated by reference in its entirety.

### TECHNICAL FIELD

The invention generally relates to electronic transactions. More particularly, the invention relates to method and apparatus for protecting against credit card fraud, laundered checks, and identity theft.

### BACKGROUND

Today, there is no workable methodology to protect consumers, businesses or credit or loan companies against credit card fraud, check laundering, and identity-theft. Typically, the actions and methods taken to protect against credit card fraud, check laundering, and identity-theft are the following: Credit Cards—Credit cards have shown to be very vulnerable objects for fraud. The federal Truth in Lending Act limits consumer liability for unauthorized charges to $50 as long as the creditor is contacted within sixty days of the date the bill was mailed. Some creditors such as Visa and Master card waive liability regardless of the time elapsed.

The problem is especially acute for online electronic transactions. One estimate is that 20 to 40 percent of online purchases are fraud attempts. According to Alvin Cameron, Credit/Loss Prevention Manager for online fulfillment house Digital River, “Merchants who cannot control the flood of fraudulent purchase attempts will soon be out of business.” At present, credit card companies only verify if a credit card number is correct and then match the credit card number against the customer's billing address.

Credit card companies force online retailers and others engaging in electronic credit card transactions to absorb the loss associated with fraudulent purchases. When a consumer indicates that a charge is fraudulent, the disputed amount is removed from the merchant's account and credited back to the customer. This “chargeback” comes with a standard fee of $15 per instance.

In an effort to minimize its exposure, MasterCard will now fine merchants if chargebacks are 1 percent or higher of total sales transactions, or 2.5 percent or higher of total sales volume for more than two consecutive months. These rules could well force smaller online retailers and others engaging in electronic credit card transactions out of the online business. However, many observers believe that MasterCard is merely trying to punish large merchants that the company sees as having lax credit card authorization policies.

Check Laundering—Check fraud has grown almost exponentially in the last few years. More than 1.2 million worthless checks enter the banking system each day. The number of cases involving fraudulent checks of $100,000 and higher has increased 300% from 1990 to 1994.

Institutions such as banks have millions of dollars in losses due to this crime. Bank Automation News estimates that the cumulative annual losses in the U.S. are beyond $10 billion annually, with banks and large corporations taking the brunt of the losses. The significance of the problem is amplified when compared to losses due to bank robberies. The Federal Bureau of Investigation reported 7,511 bank robberies in 1994 with losses of nearly $68,000,000—a mere 0.5% of check fraud losses.

Changes in the Uniform Commercial Code have brought the problem to light. Recent modifications in the code have taken sole responsibility for check fraud from the banks and have redistributed it between banks and customers. Losses and associated expenses from check fraud will continue to increase the cost of doing business for both banks and their customers unless they form a strong partnership to prevent and control the problem.

Identity Theft—Last year the Federal Trade Commission registered 27,000 calls or more regarding cases of identity-theft. Unauthorized changes to a credit file signal identity theft. Identity theft can happen in an instant but it could be 14 months or longer before the person or business discovers it. By then, the accumulated financial damage can be devastating. Correcting the problem can cost $18,000 or more and take years to re-establish credit.

Unfortunately, credit bureaus (e.g., Equifax, Experian, and TransUnion) will register this credit damage. One of the problems associated with identity theft it is the dilatory process that it takes for a party to demonstrate its innocence, while in the meantime it is liable to pay for the incurred debt. Another one of the dangerous associated problems behind identity theft lies in the risk of being indirectly involved in a first-degree felony.

Because of the lack of control existent over the aforementioned and similar transaction classes (i.e., credit card, check, new credit/loan due to robbed identity), such types of transactions are likely to attract criminals willing to swindle and, at the same time, are likely to provoke bankruptcy to individuals, businesses, banks, or similar organizations. Moreover, the lack of control existing over certain classes of transactions is not limited simply to the money lost; the lack of control may also destroy a creditor's/debtor's reputation, due to the dilatory process necessary in order to re-establish good credit again.

### BRIEF SUMMARY

No conventional methodology provides a workable solution to protect individuals, businesses or credit or loan companies against credit card fraud, check laundering and identity theft. This application describes several embodiments, one objective of which is to provide a system and method whereby a customer may be notified in real-time about specified classes of electronic transactions.

The preferred embodiments of the invention thus permit individuals/businesses/credit or loan companies to secure their transactions, otherwise lack of control in a manner stimulates hidden and fraudulent transactions, while leaving underlying criminal activity intact. They provide increased security in return for specified TC, protection and, in turn, permit banks/creditors in general to avoid fraudulent transactions.

In accordance with one aspect of at least one embodiment of the invention, a system and method of controlling the execution of electronic transactions includes: providing notification of electronic transactions to a customer; receiving real-time transaction information from a third party institution; and keeping record statistics according to threshold parameters and transaction classes.

In accordance with another aspect of at least one embodiment of the invention, a system and method includes queries to a virtual assistant (VA) from customers, for specified classes of electronic transactions and to provide information such as the amount of the transaction class (TC), the characteristics of the TC such as credit card number, check number, etc., and any other information relevant to the TC and not confined to the mentioned one, within a specified date range.

In accordance with yet another aspect of at least one embodiment of the invention, a system and method receives RI's of TC's from a specified starting location within a specified date range; querying, using a computer, voice, fax, or e-mail to a Virtual Assistant (VA), that support a wealth of access points to speech, telephony, Internet, database and third-party objects; notifying, using a unified messaging system (computer, fax, or e-mail) of said SLI to a specified customer; accepting requests of TC's relating to a specified date range or threshold characteristic; transmitting at a time subsequent to said received RI of said executed transaction, a standard notification or an alarm threshold violation notification.

In accordance with another aspect of at least one embodiment of the invention, the system and method receives and transmits messages using a Virtual Private Network (VPN) inside a public telecommunication network and performs the querying using a computer, such as a Web server collocated at the Content Provider's Content Delivery Network (CDN). The collocated Web Server preferably takes into account a nationwide deployment of the service.

The method further comprises the steps of transmitting a standard notification or an alarm threshold violation notification for said TC to the customer and Third Party Institution(s) (TPI); and receiving RI's of said TC's from TPI(s), i.e., Clearing House, Banks, etc., and not confined to the mentioned one.

In accordance with yet another aspect of at least one embodiment of the invention, there is provided a system and method for voice dictation to process customer's request, comprising the steps of: querying a TC to a Virtual Assistant (VA) residing in a distributed network architecture; examining a plurality of threshold parameters for said TC from said TTL to determine if said specified threshold parameter(s) have been violated by said TC; selecting standard notification or threshold violation notification of said type of notifications; and outputting corresponding notification to said selected TC.

Thus, at least one embodiment of the present invention provides threshold parameters necessary to capture potentially fraudulent transactions that would otherwise have remained as standard. Customers benefit from the notification by being able to control every-day's transaction events.

Because of the lack of control over transactions (i.e., credit card, check, new credit/loan due to robbed identity), such type of transactions are likely to attract criminals willing to swindle at the available credit cards, checks, vulnerable identities and, at the same time, are likely to provoke bankruptcy to individuals, businesses, banks, or similar ones. Moreover, the lack of control over transactions is not limited to a simply money lost; the lack of control may also destroy the creditors/debtors reputation, due to a dilatory process in order to re-establish credibility again. The disclosed embodiments thus permit individuals/businesses/credit or loan companies to secure their transactions, otherwise lack of control in a manner stimulates hidden and fraudulent transactions, while leaving underlying criminal activity intact.

Further aspects of the preferred embodiments of the invention will become apparent during the course of the following description and by reference to the attached drawings.

### BRIEF DESCRIPTION OF THE DRAWINGS

FIG. 1 is a block diagram illustrating a high-level embodiment of telecommunication architecture 50 of the present invention.

FIG. 2 depicts a block diagram of an exemplary virtual assistant VA 105.

FIG. 3 depicts a block diagram of an exemplary RI 115 information

FIG. 4 depicts a block diagram of an exemplary TTL 120 information

FIG. 5 depicts a block diagram of an exemplary SLI 125 information

FIG. 6 depicts a block diagram of an exemplary T-TTL 130 information

FIG. 7 depicts a block diagram of an exemplary S-TTL 135 information

FIG. 8 depicts a block diagram of an exemplary format for request information via Voice dictation 200.

FIG. 9 depicts a block diagram of an exemplary format for request information via e-mail 205.

FIG. 10 depicts a block diagram of an exemplary format for request information via fax 210.

FIG. 11 depicts a block diagram of an exemplary format for request information via dual pager/cell phone text message-based 215.

FIG. 12 illustrates the possible allocated threshold parameter values 300 for a transaction class, relative to a credit card 305.

FIG. 13 illustrates the possible allocated threshold parameter 400 values for a transaction class, relative to a check 405.

FIG. 14 illustrates the possible allocated threshold parameter values 500 for a transaction class, relative to a new credit or loan 505.

FIG. 15 illustrates an exemplary standard notification information SLI 125.

FIG. 16 illustrates an exemplary threshold violation notification information SLI 130.

FIG. 17 is a flow chart illustrating an exemplary threshold access list (TAL 140) by which a transaction class related to credit card 305 is denied to every media, every institution except during the transaction life time (TLT 145) specified by customer 110 and executed by a VA 105. TLT 145 is activated/deactivated on real-time by voice dictation, e-mail, or fax.

FIG. 18 is a flow chart illustrating an exemplary threshold access list (TAL 140) by which a transaction class related to checks 405 is denied to every person, every institution except to specified list of persons and institutions that customer 110 accept.

FIG. 19 is a flow chart illustrating an exemplary threshold access list (TAL 140) by which a transaction class related to new credit/loan 505 is denied to every institution except to specified list of institutions that customer 110 accepts.

FIG. 20 shows a block diagram of an exemplary SLR 118 information.

### DETAILED DESCRIPTION

A method according to the preferred embodiments generally consists of two parts: 1) notification; and 2) record control. Notification involves the transmission of transactions taking place on a specified transaction class (i.e., credit card, check, open new credit/loan account, etc). Record control involves a continuous monitoring of the different transaction classes being executed, so as to protect the customer against scams and thereby minimize the fraud damage to his/her credit. In particular, the objective is to demise the probability of damage as much as possible without allowing criminals to destroy your credit and/or identity.

Presently, fraudulent transactions are tractable information and can be stopped in real-time, if notification, based on customer's threshold arrangement is available.

Moreover, customers and third party institutions will know well in advance, based on real-time standard or threshold violation notification that a transaction is in progress.

Notified transaction to customers and third party institutions thus do solve the problem of fraud by demising the probability of damage as much as possible without allowing criminals to destroy his/her credit and/or identity.

Furthermore, the virtual assistant (VA) interacts with the customer by way of phone, page, e-mail, or fax to provide transaction reports to customers requesting specified transaction. The service is truly automated in that they do operate within the framework of the existing virtual assistant (VA), through which all executed transactions are retrievable in any media providing a secure access via personalized access code.

As such, there is currently no way for fraudulent activities to ruin customers credit with the support of the present invention.

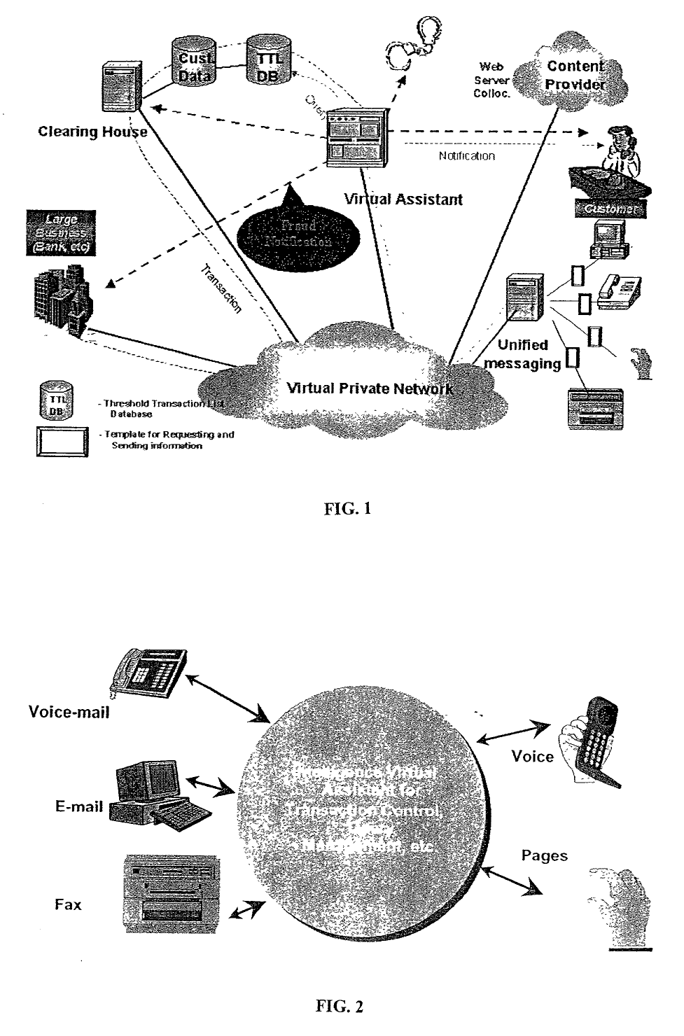

Referring now to the drawings, FIG. 1 illustrates one embodiment of the present invention.

As shown in FIG. 1, a virtual assistant VA 105 send a notification in real-time for previous transaction received from a TPI 100 (i.e., Clearing House) relevant to a specified TC 10 on a specific day. Once the VA 105 examined the TTL 120, it provides the customer the standard notification information. In the event of threshold violation, the VA 105 provides a threshold violation notification 130 (i.e., in our diagram shown as Fraud) to the TPI 100 and to the customer 110. In this scenario, the TPI 100 will send a deny-message to the party initiating the transaction PIT 50 (i.e., in our viewgraph shown as a Bank).

The VA 105, as depicted in FIG. 1, supports access to high-end databases that can be queried via voice. Templates are provided to the customer for requesting information via e-mail 1000, voice dictation 2000, fax 3000 and page 4000 for specified TC 10 (credit card, check, new credit, etc). The VA 105 transmits this SLI 125 to the customer via a unified messaging system UMS 600 in real-time.

For the actual transactions, the VA 105 will monitor each RI 115 in real-time within each transaction class TC 10 and will dynamically examine the actual parameters defined in TAL 140. In accordance with the present invention, if the actual transaction is violating some of the various threshold parameters, the VA 105 will create the SLI 125 relevant to a threshold violation notification 130.

The SLI 125 together with the violated threshold parameters is transmitted by the VA 105 via a unified messaging system UMS 600 as the embodiment shows in FIG. 1. The SLI 125 is made available to the customer and the party initiating the transaction PIT 50 through the same multimedia support. The present invention thus minimizes fraud in specialized framework since it is operable in real-time.

Examples of such VA 105 are known under the trade names PVA server and the like. Alternatively, the customer can be notified to his phone, fax, or email as default media directly from the VA 105. Notifications on transactions through a VA 105 has many advantages.

For example, being notified of a specified transaction through a VA 105 provides the customer with flexibility in responding to a fraudulent transaction and thus, permits the customer to “react on time” in order to stop the specified transaction class.

As shown in FIG. 1, a VA 105 contacts his customer 110 by way of phone, fax, online connection, e-mail or page, and provides the customer 110 with information regarding a transaction. A transaction information includes the SLI 125 relevant to the RI 115 being executed.

To request information, the customer 110 may contact the VA 105 by phone, e-mail, fax or page and obtain parameters records for all parameters that satisfy the requested transaction. Templates are provided for requesting and sending information via e-mail, voice, pages, and faxes; access restrictions, database queries via voice, setting rules, filters and thresholds for TC control; and maintaining threshold track changes database (T-TTL), are the key components of the embodiment.

The customer 110 would then request for detailed information of the specified transaction from the VA 105. One example of such benefits includes reduced risk as compared with conventional institutional' late notification of fraudulent transaction(s). If instructed by the VA 105 and, if there is threshold violation, the customer 110 will be alerted of the specified transaction through the VA 105, as well as the institutions involved in the transaction, and creates simultaneously a fraud record number FRN 999 number in the S-TTL 135. Upon alerting, the customer 110 is provided with a SLI 125 number and a notification date, by which date the VA 105 was provided with the actual threshold parameters of the specified transaction.

The VA 105 transmits in real-time, or on demand, as specified by the customer 110 in TAL 140 regarding a specified TC 10, which then forwards a notification to the customer 110. For each request, the customer 110 will obtain a listing of all actual parameters that satisfy the transaction class of specified RI 115.

In this embodiment, the customer 110 may be charged a flat rate or per notification basis.

Generally, the VA 105 attempts to minimize the dispersion of the risk by notifying a plurality of transaction parameters in real-time utilizing all the media available to the customer 110 and thereafter allocating a number to each transaction class. To this end, the VA 105 will utilize historical transaction class information stored in the TTL 120 database for prior periods, which essentially provides a transaction curve for each activity of a given transaction class on each actual parameters. For example, when allocating and setting record for an actual parameters, the VA 105 may analyze transaction trends for similar parameters from previous relevant transactions, in a known manner.

In an effort to encourage protection, an authentication password 888 is used. The password is a four word long phrase such as, i.e., “Napoleon carries my bag”, etc.

This way, the customer 110 can access to the VA 105 in order to request transactions made in a date range, change the thresholds per transaction class, etc.

A four digit PIN number 777 is used in the case the customer 110 forgot or would like simply change his/her authentication password 888.

It is to be understood that the VA 105 may also track the associated transaction classes together with the actual number of threshold violations taken place per transaction class and its respective threshold parameters. Over time, this will provide with a curve for each transaction at per given transaction class. Enforcement institutions can then use this information, in order to determine the ratio of fraud per transaction class and the ratio of fraud per actual threshold parameters.

As depicted, FIG. 2 shows a block diagram of an exemplary virtual assistant VA 105.

As depicted, FIG. 3 shows a block diagram of an exemplary RI 115 information

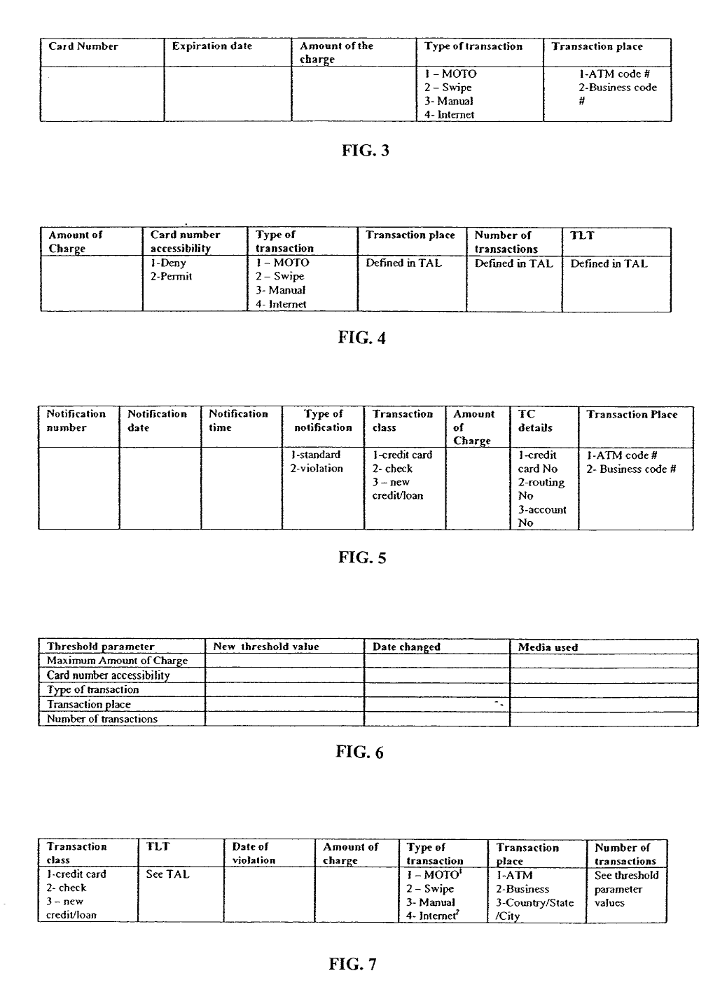

As depicted, FIG. 4 shows a block diagram of an exemplary TTL 120 information

As depicted, FIG. 5 shows a block diagram of an exemplary SLI 125 information

As depicted, FIG. 6 shows a block diagram of an exemplary T-TTL 130 information

As depicted, FIG. 7 illustrates a block diagram of an exemplary S-TTL 135 information

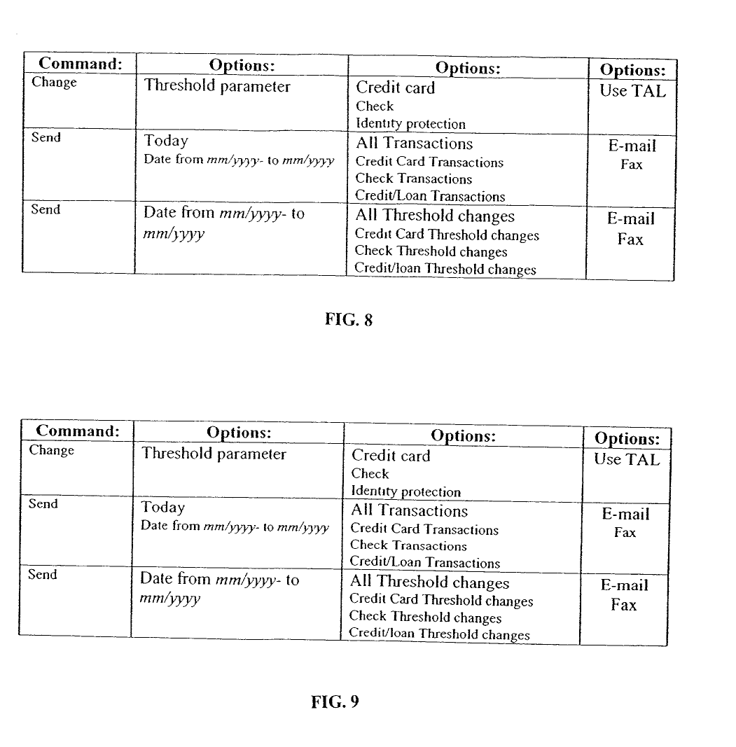

As depicted, FIG. 8 illustrates a block diagram of an exemplary format 200 for request information via Voice dictation 2000.

As depicted, FIG. 9 illustrates a block diagram of an exemplary format 205 for request information via e-mail 1000.

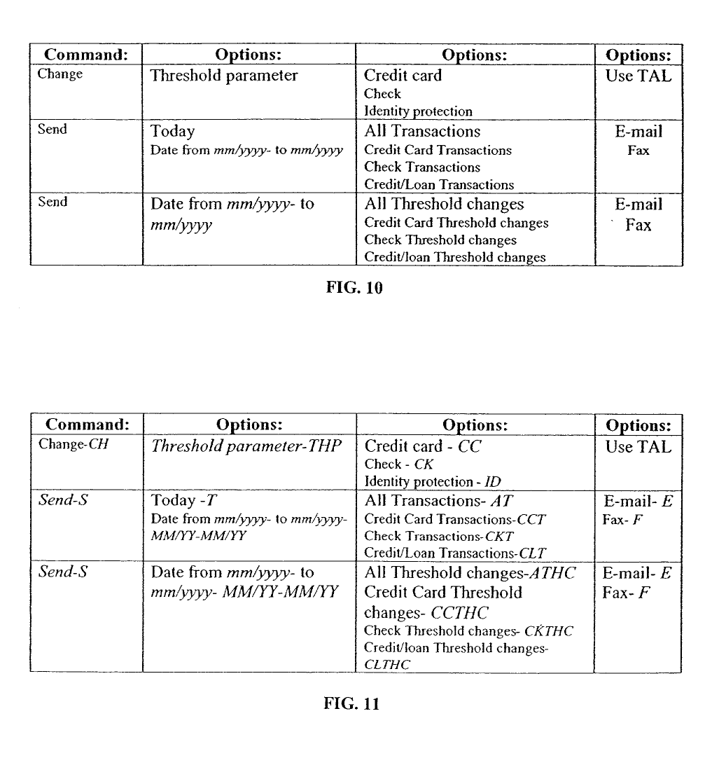

As depicted, FIG. 10 illustrates a block diagram of an exemplary format 210 for request information via fax 3000.

As depicted, FIG. 19 illustrates a block diagram of an exemplary format 215 for request information via dual pager/cell phone text message-based 4000.

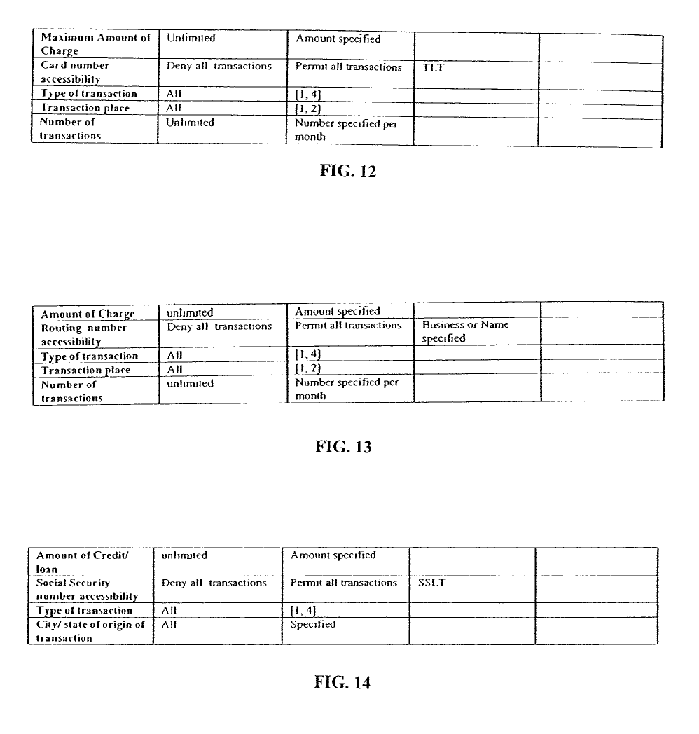

As depicted, FIG. 12 illustrates the possible allocated threshold parameter values 300 for a transaction class, relative to a credit card 305.

As depicted, FIG. 13 illustrates the possible allocated threshold parameter 400 values for a transaction class, relative to a check 405.

As depicted, FIG. 14 illustrates the possible allocated threshold parameter values 500 for a transaction class, relative to a new credit or loan 505.

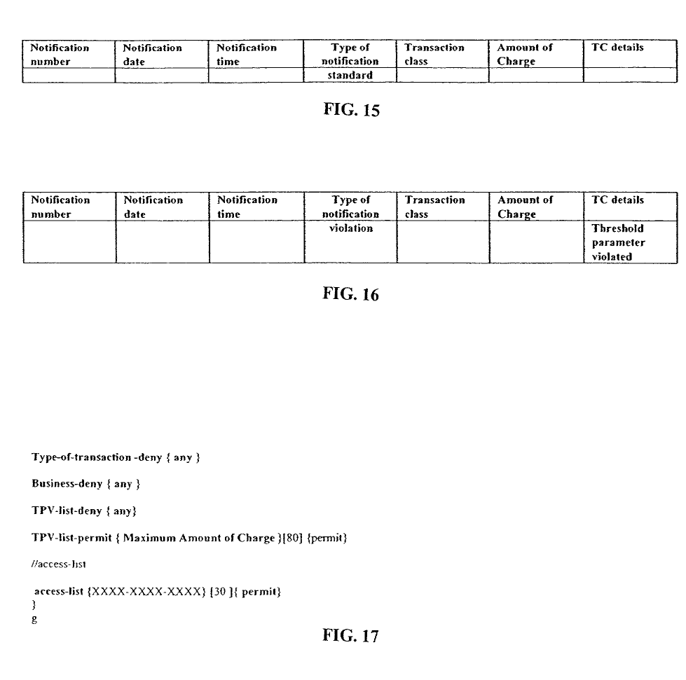

As depicted, FIG. 15 illustrates an exemplary standard notification information SLI 125.

As depicted, FIG. 16 illustrates an exemplary threshold violation notification 130 information SLI 125.

As depicted, FIG. 17 shows an exemplary threshold access list TAL 140 by which a transaction class related to credit card 305 is denied to every type-of-transaction, every business except to transactions less than 80 and executed during the transaction life time TLT 145 specified by customer 110 and executed by a VA 105. TLT 145 is activated/deactivated on real-time by voice dictation 2000, e-mail 1000, or fax 3000 or page/cellphone text-message based 4000.

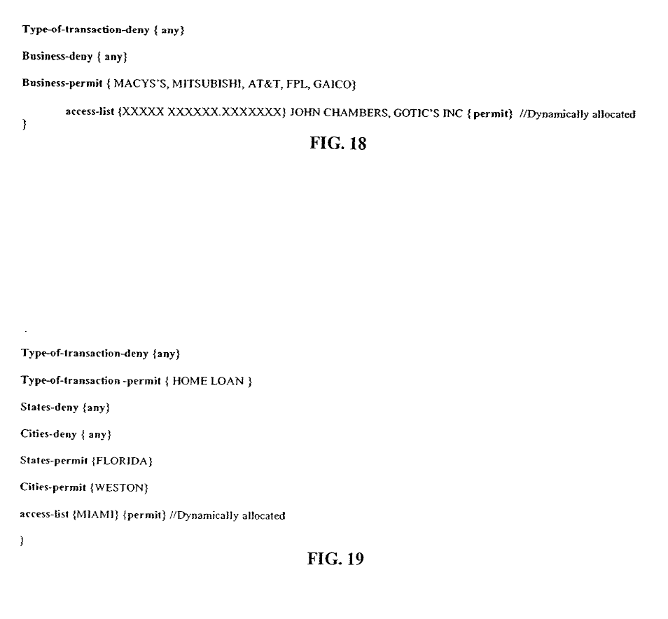

As depicted, FIG. 18 is a flow chart illustrating an exemplary threshold access list (TAL 140) by which a transaction class related to checks 405 is denied to every type-of-transaction, every person and every business except to specified list of persons and business that customer 110 accept.

As depicted, FIG. 19 is a flow chart illustrating an exemplary threshold access list (TAL 140) by which a transaction class related to new credit/loan 505 is denied to every State, City and to every business except to specified list of States or Cities that customer 110 may need a new credit or loan.

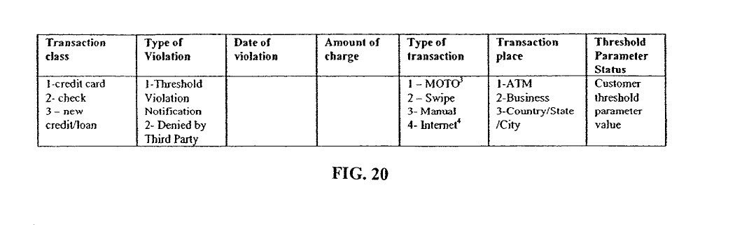

As depicted, FIG. 20 shows a block diagram of an exemplary SLR 118 information.

The many features and advantages of the present invention are apparent from the detailed specification, and thus, it is intended by the appended claims to cover all such features and advantages of the invention which fall within the true spirit and scope of the present invention.

Furthermore, since numerous modifications and variations will readily occur to those skilled in the art, it is not desired that the present invention be limited to the exact construction and operation illustrated and described herein, and accordingly, all suitable modifications and equivalents which may be resorted to are intended to fall within the scope of the claims.

I claim:

1. A method comprising the steps of:
storing, using a telecommunications network, special database listing information for transactions (SLI) specifying the initiating location of a transaction class (TC), the amount of the TC, the characteristics of the TC, and any other information relevant to the TC, within a specified date range;
transmitting notifications to customers, using a Virtual Assistant (VA) that connects to a unified messaging system with a plurality of access points to speech, telephony, Internet, database and third-party objects;
accepting queries from customers, for specified TC's and to provide the amount of the TC, the characteristics of the TC, and any other information relevant to the TC, within a specified date range; and
receiving real-time transaction-based information for a specified TC (RI) from a
committed third party not confined to said transaction activity.

2. The method of claim 1, wherein said step of accepting said RI includes one of making available a SLI corresponding to the executed TC.

3. The method of claim 1, wherein said transmitting notifications of TC's comprises receiving RI's related to credit card, check, transactions and establishment of new credit/loan accounts, etc.

4. The method of claim 1, wherein said receiving RI's includes transaction threshold policing that further does specify a type of notification.

5. The method of claim 4, further comprising the steps of:
transmitting a type of notification based on said customer threshold policing information; and
keeping track of said TTL (T-TTL).

6. The method of claim 5, wherein said notification is a transaction in progress.

7. The method of claim 1, wherein said accepting queries includes templates defined for access via phone, e-mail, pager and fax.

8. The method of claim 1, wherein said receiving a RI includes transmitting a SLI that further specify the amount of the TC, the characteristics of the TC, and any other information relevant to the TC, within a specified date range.

9. The method of claim 1, further comprising the step of accepting TC queries from a customer taking the service thereon.

10. The method of claim 9, wherein said step of accepting queries of said TC includes transmitting SLI's with said amount of the TC, the characteristics of the TC, and any other information relevant to the TC and not confined to the mentioned one, within a specified date range provided thereon.

11. A method comprising the steps of:
receiving RI's of TC's from a specified starting location within a specified date range;
querying, using a computer, voice, fax, or e-mail to a Virtual Assistant (VA), that supports a plurality of access points to speech, telephony, Internet, database and third-party objects;
notifying, using a unified messaging system (computer, fax, or e-mail) of said SLI to a specified customer;
accepting requests of TC's relating to a specified date range or threshold characteristic;
transmitting, at a time subsequent to said received RI of said executed transaction, a standard notification or an alarm threshold violation notification.

12. The method of claim 11, wherein said receiving and transmitting includes using a Virtual Private Network (VPN) inside a public telecommunications network.

13. The method of claim 11, wherein said querying using a computer includes a Web server collocated at a Content Provider's network.

14. The method of claim 11, further comprising the steps of:
transmitting a standard notification or an alarm threshold violation notification for said TC to the customer and a third party; and
receiving RI's of said TC's from said third party.

15. The method of claim 14, wherein said TC is a transaction in progress.

16. The method of claim 13, wherein said Content Provider includes a Content Delivery Network (CDN).

17. The method of claim 13, wherein said collocated Web Server takes into account a nationwide deployment of the service thereon.

18. A system comprising:
an intelligent telecommunication network having embodied therein the power of information-on-demand, real-time, instant access to data, automated event and notification relating to a plurality of threshold parameters, and transaction information relating to a plurality of TC's; and
a Virtual Assistant (VA) connected to said intelligent telecommunication network and configured to transmit through a VPN network and reach the customer via a unified messaging system.

19. The system of claim 18, wherein said Virtual Assistant (VA) is configured to make available TC's and to receive a request for said executed transaction; and transmit a notification of said executed transaction.

20. The system of claim 19, wherein said Virtual Assistant (VA) is further configured to receive a transaction for said RI's from a third party, transmit a standard notification of said transaction to said customer; and output a threshold violation notification to the customer and the third party.
